(19) United States
(12) Patent Application Publication
(10) Pub. No.: US 2020/0202232 A1
(43) Pub. Date: Jun. 25, 2020

(54) PRODUCTION RECORD DATA ANALYZER

(71) Applicant: Hitachi, Ltd., Tokyo (JP)

(72) Inventor: Satoshi NAGAHARA, Tokyo (JP)

(21) Appl. No.: 16/703,982

(22) Filed: Dec. 5, 2019

(30) Foreign Application Priority Data
Dec. 25, 2018 (JP) 2018-241564

(51) Int. Cl. G06N 5/02; G06N 5/04; G06N 20/00

(52) U.S. Cl. CPC G06N 5/025; G06N 20/00; G06N 5/04

(57) ABSTRACT

Event data includes information on events in each process. Each dispatching rule model in each dispatching rule model set is configured to anticipate a job to be selected next from waiting jobs in an event in a process associated with the dispatching rule model set. One or more processors are configured to: generate anticipation results of a selected event with the plurality of dispatching rule models associated with the process; determine reliability of the selected event based on whether each of the jobs indicated in the anticipation results is the same as the job actually selected in the selected event shown in the production record data in each of the plurality of processes; and determine whether to include the selected event to training data for generating a new dispatching rule model based on the reliability in each of the plurality of processes.

### CLAIM OF PRIORITY

The present application claims priority from Japanese patent application JP2018-241564 filed on Dec. 25, 2018, the content of which is hereby incorporated by reference into this application.

### BACKGROUND OF THE INVENTION

This invention relates to a production record data analyzer for analyzing production record data in a production site such as a factory.

Typical production planning for a production site like a factory includes predicting future production under given conditions and obtaining conditions to maximize the future evaluation indicators such as throughput and on-time delivery rate. Production simulation is a representative way of production prediction. To achieve highly precise production prediction, modeling a dispatching rule that fits the reality of the production site is necessary.

The dispatching rule is a rule for determining a job to be executed next from waiting jobs in a given process. The rule is likely to be implicit, particularly in the case where a man dispatches the jobs in a production site. For this reason, it has been common to employ an existing rule such as first-in first-out rule or earliest due date rule as dispatching rule (hereinafter, referred to as dispatching rule model) in production simulation, based on hearing in the production site.

However, the dispatching rule model determined as described above does not always fit the reality of the production site. If the dispatching rule model is away from the reality, the prediction accuracy in the production simulation reduces. Accordingly, the production plan created based on this prediction has small feasibility or optimality.

To address this problem, there is an approach that crates a model of the dispatching rule from previous production record data. For example, a model approximated to a dispatching rule that outputs a job anticipated to be executed next in response to input of a waiting job list can be obtained by applying machine learning to the production record data, as described in Approximation of Dispatching Rules for Manufacturing Simulation using Data Mining Methods (Proceedings of the 2015 Winter Simulation Conference).

### SUMMARY OF THE INVENTION

The aforementioned Approximation of Dispatching Rules for Manufacturing Simulation using Data Mining Methods provides a method of modeling a dispatching rule that implicitly exists in a production site (hereinafter, referred to as implicit rule). However, in the case where jobs are dispatched by a man, his decision-making involves uncertainties. For example, when a large number of jobs are in the waiting list, it is difficult to select a next job conforming to the implicit rule every time; a job deviating from the implicit rule could be selected as a next job.

Production record data includes a record of job selection deviating from the implicit rule. This deviation from the rule causes inconsistency between the dispatching rule model and the actual implicit rule. In view of the foregoing, demanded is reducing the effect of the deviation from the rule in obtaining a dispatching rule model from production record data.

An aspect of this disclosure is a production record data analyzer including one or more storage devices and one or more processors. The one or more storage devices store: a plurality of dispatching rule model sets and event data in production record data. The event data includes information on events in each of a plurality of processes. An event is that a job to be executed next in a process is selected from jobs waiting to be executed in the process. Each of the plurality of dispatching rule model sets is composed of a plurality of dispatching rule models. Each dispatching rule model in each dispatching rule model set is configured to anticipate a job to be selected next from waiting jobs in an event in a process associated with the dispatching rule model set. The one or more processors are configured to: generate anticipation results of a selected event with the plurality of dispatching rule models of the dispatching rule model set associated with the process; determine reliability of the selected event based on whether each of the jobs indicated in the anticipation results is the same as the job actually selected in the selected event shown in the production record data in each of the plurality of processes; and determine whether to include the selected event to training data for generating a new dispatching rule model based on the reliability in each of the plurality of processes.

An aspect of this disclosure enables creation of a dispatching rule model consistent to an actual dispatching rule in a production site.

### BRIEF DESCRIPTION OF THE DRAWINGS

FIG. 1 is a schematic diagram of an example of a production process;

FIG. 2A is a functional block diagram of a production record data analyzer;

FIG. 2B is a configuration diagram of hardware and software of the production record data analyzer;

FIG. 3 is a simplified diagram of a production record table;

FIG. 4 is a simplified diagram of an event table;

FIG. 5 is a simplified diagram of an advanced event table;

FIG. 6 is a simplified diagram of a dispatching rule model table;

FIG. 7 is a simplified diagram of a selected-job anticipation result table;

FIG. 8 is a flowchart of the processing of a control unit of the production record data analyzer;

FIG. 9 is a simplified diagram of an example of an image of a user interface; and

FIG. 10 is a schematic diagram of an example of a production planning system in an embodiment.

### DETAILED DESCRIPTION OF THE EMBODIMENTS

Hereinafter, embodiments of this invention are described with reference to the accompanying drawings. It should be noted that the embodiments are merely examples to implement this invention and are not limit the technical scope of this invention.

In an embodiment, the production record data analyzer obtains a dispatching rule model set from production record data for each of a plurality of processes. The dispatching rule model set is composed of a plurality of dispatching rule models. The production record data analyzer evaluates the reliability of the actual selection of a next job (hereinafter, referred to as job selection event or simply, event) in each process shown in the production records with the dispatching rule models. The production record data analyzer excludes data concerning less reliable events from the production record data and creates a new dispatching rule model using the remaining data as training data. As a result, a new model approximated to the actual dispatching rule can be created with less effect of the deviation from the rule in the production records.

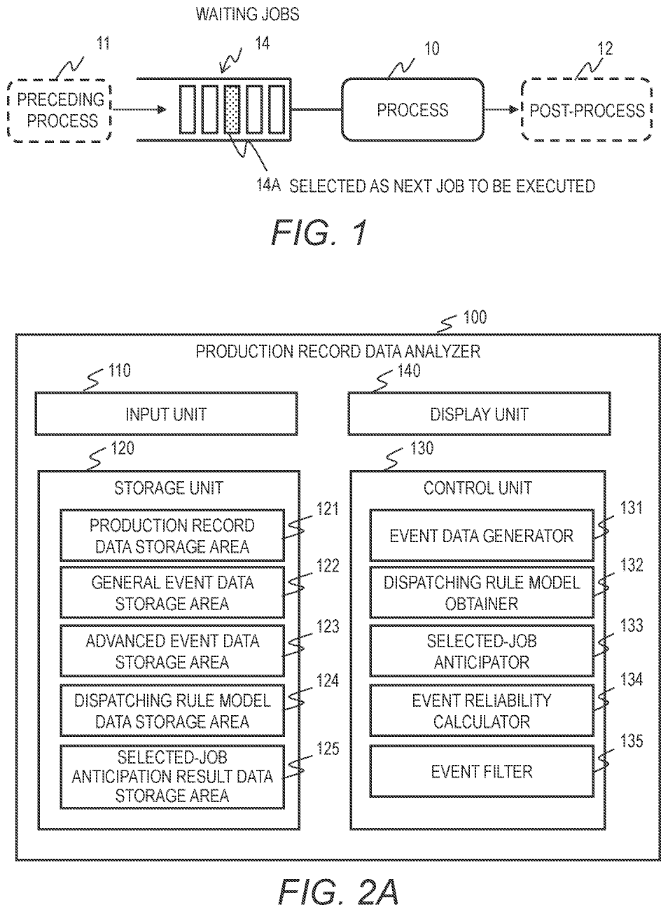

FIG. 1 is a schematic diagram of a production process to be discussed in this embodiment. In this example, there are a preceding process 11 and a post-process 12 before and after a production process (also simply referred to as process) 10, which is discussed in this embodiment. As illustrated in FIG. 1, one or more jobs 14 are waiting to be executed in the process 10 and a job 14A is selected to be executed next from these jobs 14. After the next job 14A is selected, the process of the job 14A is started and the time of the start is recorded to production record data. When the process of the job is finished, the time of the finish is recorded to the production record data.

The jobs are executed in one or more production processes. A job can be identified with work and the objects involved with the work. The objects include the object to be produced, namely the product, and equipment to be used to work on the product. The equipment includes an object including a movable part like a processing machine and other objects such as a working table and a jig. An example of a job includes processing a product, moving the product, and maintaining the equipment. If objects are different, the jobs on the objects are different. A plurality of jobs can be executed in one production process. As described above, the jobs are selected one by one from a plurality of waiting jobs to be executed in one process. In the example to be described hereinafter, a man selects the jobs to be executed in one or more processes in a production flow including a plurality of processes.

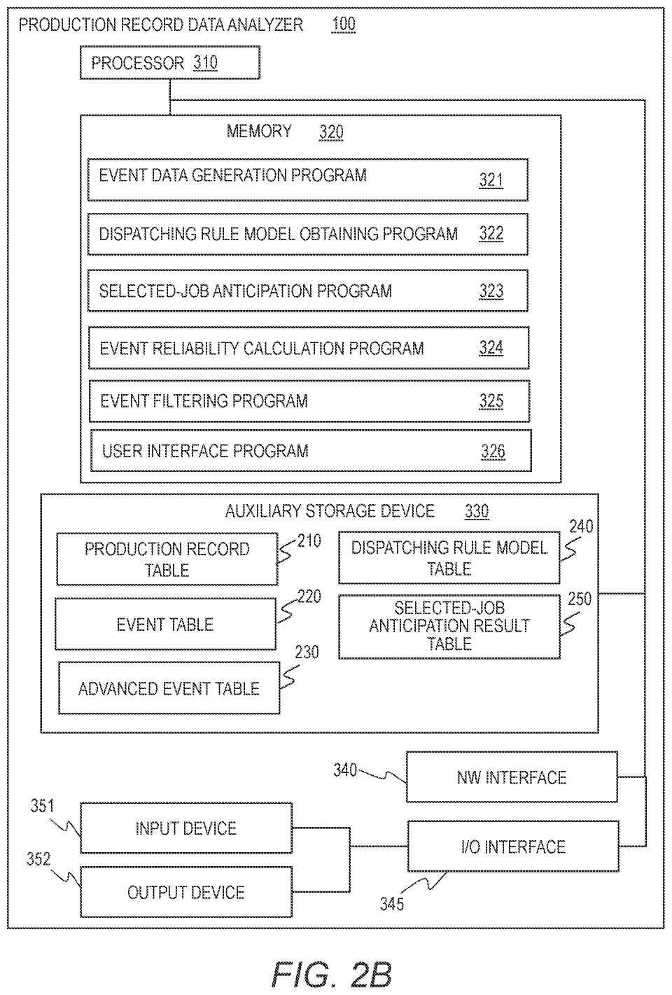

FIG. 2A is a functional block diagram of a production record data analyzer 100. As illustrated, the production record data analyzer 100 includes an input unit 110, a storage unit 120, a control unit 130, and a display unit 140. The input unit 110 receives production record data from outside of the production record data analyzer 100. The display unit 140 presents information to the external (the user). The control unit 130 includes an event data generator 131, a dispatching rule model obtainer 132, a selected-job anticipator 133, an event reliability calculator 134, and an event filter 135.

The storage unit 120 has a production record data storage area 121, a general event data storage area 122, an advanced event data storage area 123, a dispatching rule model data storage area 124, and a selected-job anticipation result data storage area 125.

The production record data storage area 121 stores information for identifying previous records of each production process. The general event data storage area 122 stores general information on each event that a job is selected to be executed next. The advanced event data storage area 123 stores in-depth information on each event. General event data, advanced event data, or the combination of these is event data.

The dispatching rule model data storage area 124 stores information on the dispatching rule models obtained from the aforementioned general event data and advanced event data. The selected-job anticipation result data storage area 125 stores information on the selected job in each event anticipated by each dispatching rule model.

FIG. 2B illustrates a configuration example of hardware and software of the production record data analyzer 100. In the example of FIG. 2B, the production record data analyzer 100 is a single computer. The production record data analyzer 100 includes a processor 310, a memory 320, an auxiliary storage device 330, a network (NW) interface 340, an I/O interface 345, an input device 351, and an output device 352. These elements are interconnected by a bus. The memory 320, the auxiliary storage device 330, or the combination of these is a storage device including a non-transitory storage medium; they correspond to the storage unit 120.

The memory 320 can be a semiconductor memory; it is mainly used to hold programs and data. The programs stored in the memory 320 include a not-shown operating system and further, an event data generation program 321, a dispatching rule model obtaining program 322, a selected-job anticipation program 323, an event reliability calculation program 324, an event filtering program 325, and a user interface program 326.

The processor 310 performs a variety of processing in accordance with the programs stored in the memory 320. The processor 310 operates in accordance with the programs to implement various function units. For example, the processor 310 operates in accordance with the aforementioned programs to work as the control unit 130, specifically, the event data generator 131, the dispatching rule model obtainer 132, the selected-job anticipator 133, the event reliability calculator 134, and the event filter 135. The processor 310 operates in accordance with the user interface program 326 to work as the input unit 110 and the display unit 140.

The auxiliary storage device 330 stores a production record table 210, an event table 220, an advanced event table 230, a dispatching rule model table 240, and a selected-job anticipation result table 250. These tables are stored in the production record data storage area 121, the general event data storage area 122, the advanced event data storage area 123, the dispatching rule model data storage area 124, the selected-job anticipation result data storage area 125. The auxiliary storage device 330 can be configured with large-capacity storage devices such as hard disk drives or solid-state drives; it is used to hold programs and data on a long-term basis.

For convenience of explanation, the programs 321 to 326 are stored in the memory 320 and the tables 210, 220, 230, 240, and 250 are stored in the auxiliary storage device 330; however, the storage locations of the data in the production record data analyzer 100 are not limited to the foregoing locations. For example, the programs stored in the auxiliary storage device 330 are loaded to the memory 320 at the start-up or when needed and executed by the processor 310 to perform a variety of processing of the production record data analyzer 100. Accordingly, the agents of processing of a function unit, the processor 310, and the production record data analyzer 100 are replaceable with one another.

The network interface 340 is an interface for connecting the production record data analyzer 100 to a network. The production record data analyzer 100 communicates with other apparatuses in the system through the network interface 340. The input device 351 is a hardware device for the user to input an instruction or information and includes a keyboard and a pointing device, for example. The output device 352 is a hardware device for showing images for input and output and can be a display device.

The production record data analyzer 100 includes one or more processors and one or more storage devices. Each processor can include one or more computing units or processing cores. The processor can be implemented with a central processing unit, a microprocessor, a microcomputer, a microcontroller, a digital signal processor, a state machine, a logic circuit, a graphic processing unit, a chip-on system, and/or any device that operates a signal in accordance with a control instruction.

The functions of the production record data analyzer 100 can be implemented by distributed processing of a computer system including multiple computers. The multiple computers communicate with one another through a network to cooperatively perform the processing.

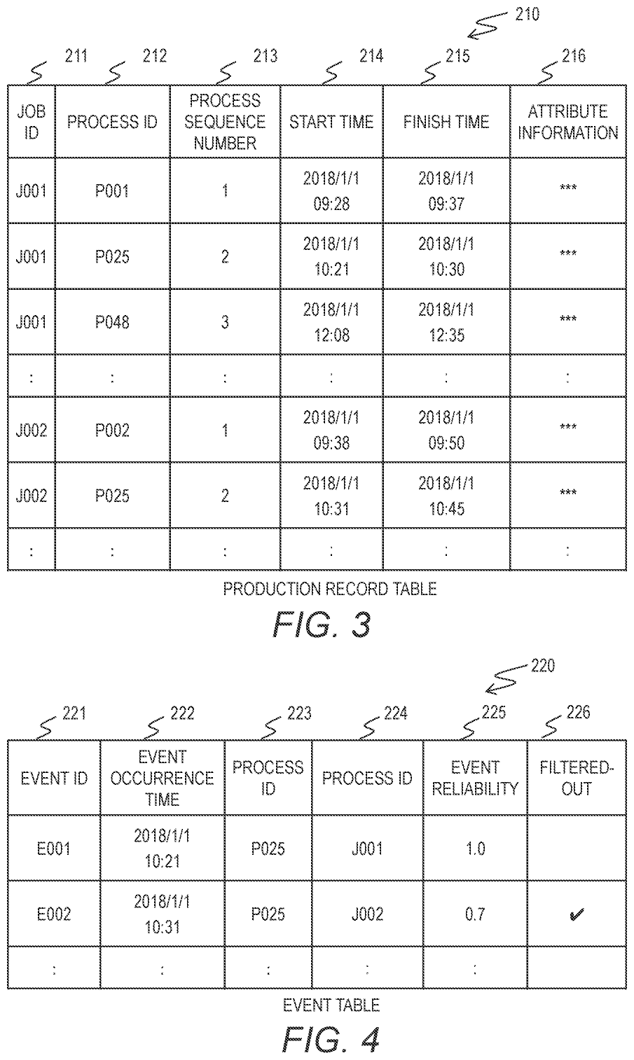

FIG. 3 provides a configuration example of the production record table 210. The production record table 210 is stored in the production record data storage area 121 and it is an example of information for identifying previous records of production processes. The production record table 210 is prepared in advance in the production record data analyzer 100. The production record table 210 has a job ID column 211, a process ID column 212, a process sequence number column 213, a start time column 214, a finish time column 215, and an attribute information column 216. Each row of this table is identified by a job ID and a process sequence number.

The job ID column 211 stores information for identifying a job. The process ID column 212 stores information for identifying a process. The process sequence number column 213 stores information on the process sequence number of the process in the job. The process sequence number is information for identifying the position of the process in the series of processes the product of the job goes through.

The start time column 214 and the finish time column 215 store the actual times (in this example, in date and time) at which the process of the job is started and finished, respectively. The attribute information column 216 stores attribute information on the job and the process. The attribute information is information to identify the type, the size, and/or the delivery time of the product handled by the job, the equipment used in the process of the job, and/or the worker who performs the job.

FIG. 4 provides a configuration example of the event table 220. The event table 220 is stored in the general event data storage area 122 and is an example of general information on each event that a job is selected to be executed next. The information in the event table 220 is generated by the event data generator 131 and the event reliability calculator 134 as will be described later.

The event table 220 has an event ID column 221, an event occurrence time column 222, a process ID column 223, a selected job ID column 224, an event reliability column 225, and a filtered-out column 226; each row is identified by an event ID. The event ID column 221 stores information for identifying an event. The event occurrence time column 222 stores information on the date and time when the event occurs.

The process ID column 223 stores information for identifying the process in which the event occurs. The selected job ID column 224 stores information for identifying the job selected as the next job in the event. The event reliability column 225 stores information on the reliability of the event calculated by the event reliability calculator 134. The filtered-out column 226 stores information indicating that the event is excluded by the event filter 135.

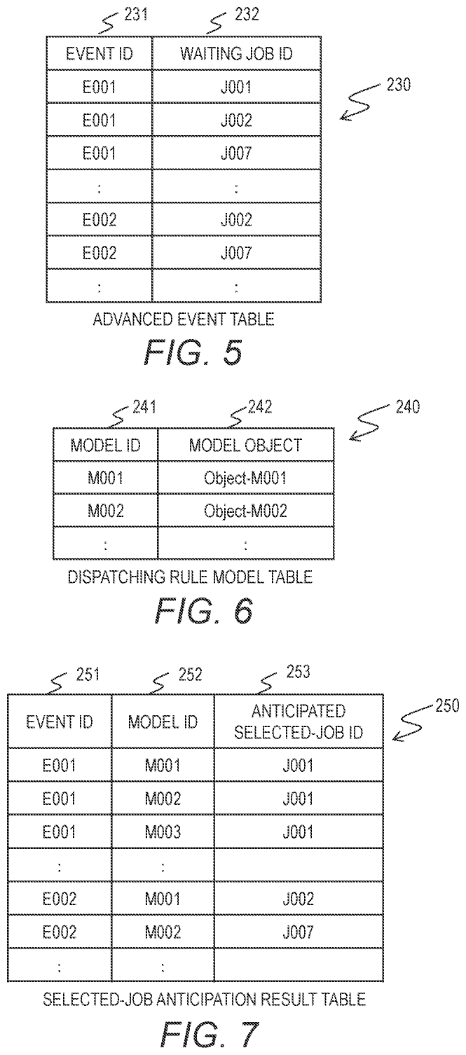

FIG. 5 provides a configuration example of the advanced event table 230. The advanced event table 230 is stored in the advanced event data storage area 123; it is an example of advanced information on each event. The information in the advanced event table 230 is generated by the event data generator 131, as will be described later. The advanced event table 230 has an event ID column 231 and a waiting job ID column 232. The event ID column 231 stores information for identifying an event. The waiting job ID column 232 stores information for identifying a job that is waiting to be executed when the event occurs.

FIG. 6 provides a configuration example of a dispatching rule model table 240. The dispatching rule model table 240 is stored in the dispatching rule model data storage area 124; it is an example of information on dispatching rule models obtained from the event table 220 and the advanced event table 230.

The dispatching rule model table 240 has a model ID column 241 and a model object column 242. The model ID column 241 stores information for identifying a dispatching rule model. The model object column 242 stores a model data structure object including detailed information on the model.

For example, in the case where a neural network is used for the dispatching rule model, the model data structure object is a data structure object composed of information such as input and output parameters of the neural network, the number of units in the hidden layers, the values of the weight coefficients and bias coefficients for the input layer—the hidden layers and the hidden layers—the output layer, and the activating functions of individual layers. The scheme to be employed for the dispatching rule model is not limited to a specific one. The dispatching rule model can be any type of model as far as it inputs information on waiting jobs and outputs a result of anticipation of the next job to be selected.

FIG. 7 provides a configuration example of the selected-job anticipation result table 250. The selected-job anticipation result table 250 is stored in the selected-job anticipation result data storage area 125; it is an example of information on the selected job in each event that is anticipated by each dispatching rule model. The information in the selected-job anticipation result table 250 is generated by the selected-job anticipator 133.

The selected-job anticipation result table 250 has an event ID column 251, a model ID column 252, and an anticipated selected-job ID column 253; each row is identified by an event ID and a model ID. The event ID column 251 stores information for identifying an event. The model ID column 252 stores information for identifying a dispatching rule model. The anticipated selected-job ID column 253 stores information for identifying the selected job in the event that is anticipated by the dispatching rule model.

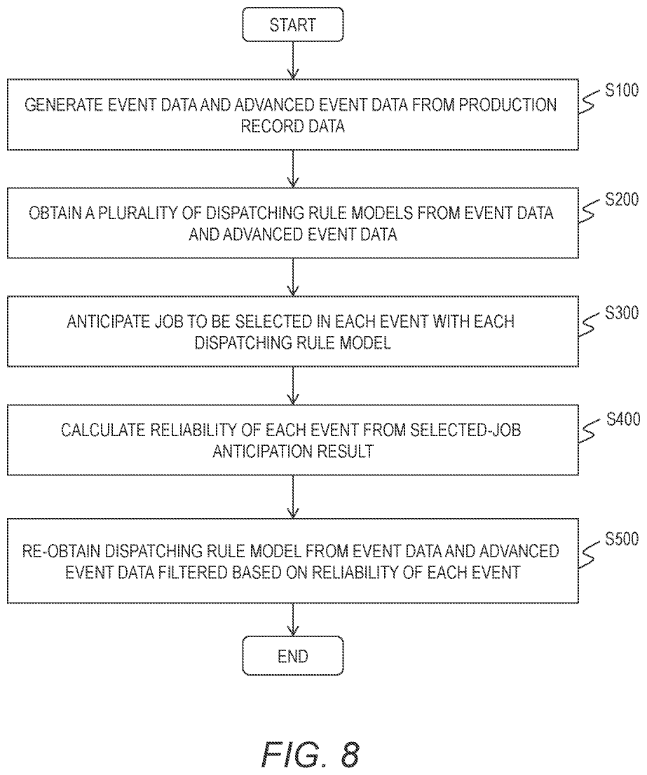

FIG. 8 is a flowchart of the processing of the control unit 130. Hereinafter, the processing in this embodiment is described in accordance with this flowchart. Step S100 is executed by the event data generator 131. The event data generator 131 generates an event table 220 and an advanced event table 230 from the production record table 210.

Specifically, the event data generator 131 generates general event data while taking a record of execution of a job in some process in the production record table 210 as an event of selecting the job in the process and stores the generated data to the event table 220. The start time of the job in the process is used as the event occurrence time.

Next, the event data generator 131 acquires waiting jobs in each event from the production record table 210 and stores them to the advanced event table 230. Specifically, the event data generator 131 acquires the jobs for which the process is started after the event occurrence time and the preceding process is finished before the event occurrence time as waiting jobs. The preceding process of a given process is the process assigned a process sequence number reduced by one from the process sequence number of the process for the jobs. The jobs for which the preceding process is not included the production record table 210 are not included in the waiting jobs.

As understood from the above, the event data generator 131 identifies the job selected as the next job and the waiting jobs in each event based on the start times and the finish times of the jobs. Thus, appropriate event data can be extracted from the production record data.

Step S200 is executed by the dispatching rule model obtainer 132. The dispatching rule model obtainer 132 obtains dispatching rule models from the event table 220 and the advanced event table 230 generated by the event data generator 131 and stores the information on the generated models to the dispatching rule model table 240. A plurality of dispatching rule models are generated for each process. Appropriate dispatching rule models can be generated for each process through the processing of the dispatching rule model obtainer 132.

Specifically, the dispatching rule model obtainer 132 applies machine learning such as regression or classification using information on the waiting jobs in each event as explanatory variables and the selected job in each event as a label to obtain dispatching rule models. The dispatching rule model obtainer 132 stores information on the dispatching rule models to the dispatching rule model table 240.

A dispatching rule model anticipates a selected job (outputs a selected job as a label) from input information on the waiting jobs. The input of the dispatching rule model can include information other than the information on the waiting jobs. For example, the input can include information on past records of the jobs in the same process and/or environmental information for the process such as information on the mode of the equipment to be used in the process.

The information on the waiting jobs to be used as explanatory variables can include the waiting time of each waiting job (for example, the time from the date and time when the preceding process is finished to the date and time when the event occurs) or the job attribute information such as the type and the delivery time of the product. The machine learning can employ a scheme such as decision tree or neural network. However, this embodiment is not to limit the information to be used as explanatory variables or the scheme of the machine learning.

The dispatching rule model obtainer 132 in this embodiment obtains a dispatching rule model set composed of a plurality of different dispatching rule models for each process from the event table 220 and the advanced event table 230. In an example, the dispatching rule model obtainer 132 obtains a plurality of dispatching rule models using a plurality of different machine learning schemes such as decision tree and neural network.

In another example, the dispatching rule model obtainer 132 divides the general event data in the event table 220 into N groups and obtains dispatching rule models using the N data groups individually. Overlap of information can be reduced by dividing the data along the time. For example, each of the plurality of data groups corresponds to data on events that occur in different time periods; each period is isolated and does not include an overlap. For example, a predetermined interval is provided between the periods for data groups. As a result, more diverse models can be created. The event data can also be grouped by worker.

In still another example, the dispatching rule model obtainer 132 obtains a plurality of different dispatching rule models that are of the same kind but have different parameter sets. Alternatively, the plurality of dispatching rule models can include dispatching rule models generated by different methods and each dispatching rule model can be generated by a plurality of different methods. For example, the dispatching rule model obtainer 132 divides event data and obtains a plurality of different dispatching rule models from different kinds of models using different data groups. These approaches lead to creation of more diverse models.

As described above, at least a part of the plurality of dispatching rule models can be configured with different machine learning schemes. Furthermore, at least a part of the plurality of dispatching rule models can be trained by different datasets.

Step S300 is executed by the selected-job anticipator 133. The selected-job anticipator 133 calculates results of anticipation of the job to be selected in each event with the plurality of dispatching rule models obtained by the dispatching rule model obtainer 132. Specifically, the selected-job anticipator 133 inputs information on waiting jobs and other necessary information in each event to each dispatching rule model to anticipate a job to be selected and stores the anticipation result to the selected-job anticipation result table 250.

The selected-job anticipator 133 can determine the job to be selected in the event using the record data used in generating the plurality of dispatching rule models, namely the event table 220 and the advanced event table 230, or other record data.

Step S400 is executed by the event reliability calculator 134. The event reliability calculator 134 calculates the reliability of each event using the selected-job anticipation results of the dispatching rule models in each event that are calculated by the selected-job anticipator 133. Specifically, the event reliability calculator 134 determines the reliability of an event based on whether the job indicated in each anticipation result is the same as the selected job in the production record data. The event reliability calculator 134 stores the calculated reliability to the event reliability column 225 of the event table 220.

The reliability represents how far the event conforms to the implicit rule in the production site. Here is an example of the method of calculating the reliability. Let the job actually selected in an event Ei be Ji and the selected job in the event Ei anticipated by a dispatching rule model Dk (k=1, 2, . . . , K, where K is the number of dispatching rule models) be Dj(Ei). The event reliability calculator 134 calculates the value Ri obtained by the following formula (1) as the reliability of the event Ei:

$${R}_{i} = \frac{{\sum }_{k = 1}^{K} δ ( {D}_{k} ( {E}_{i} ) = {J}_{i} )}{K} ,$$

where σ(⋅) is a function that results in 1 when the logical expression in the parenthesis is true and 0 when false. The reliability calculated by the formula (1) becomes 1 when the jobs anticipated by all dispatching rule models for a given event are the same as the actually selected job and 0 when all the anticipated jobs are different from the actually selected job. In other words, an event in which more dispatching rule models anticipate a correct job is determined to be more reliable.

Step S500 is executed by the event filter 135 and the dispatching rule model obtainer 132. The event filter 135 filters the events based on the reliability of each event calculated by the event reliability calculator 134. The dispatching rule model obtainer 132 obtains one or more new dispatching rule models using the filtered event data.

Specifically, the event filter 135 extracts event data on events having reliability higher than its threshold and includes the extracted data to the training data for generating a new dispatching rule model. The event filter 135 inputs information indicating that the event is excluded to the filtered-out column 226 of the event table 220. In this way, the event filter 135 determines whether to include each event to the training data for generating a new dispatching rule model based on the reliability.

The dispatching rule model obtainer 132 obtains one or more new dispatching rule models using the extracted event data (training data) and stores the information on the obtained dispatching rule model to the dispatching rule model table 240. The newly generated dispatching rule model can have a configuration different from any of the configurations of the dispatching rule models used to extract reliable event data or the same configuration as one of them.

The job selected by a plurality of dispatching rule models can be determined from the jobs selected by the plurality of dispatching rule models by the rule of majority. Alternatively, probabilities of selection for individual waiting jobs can be obtained from each dispatching rule model and a job can be selected based on the statistic scores of the probabilities of the waiting jobs. As described above, extracting reliable event data to use them as training data leads to creation of a dispatching rule model consistent to the actual dispatching rule in the production site. As a result, the accuracy in predicting future production increases and the feasibility and the optimality of the production plan improve.

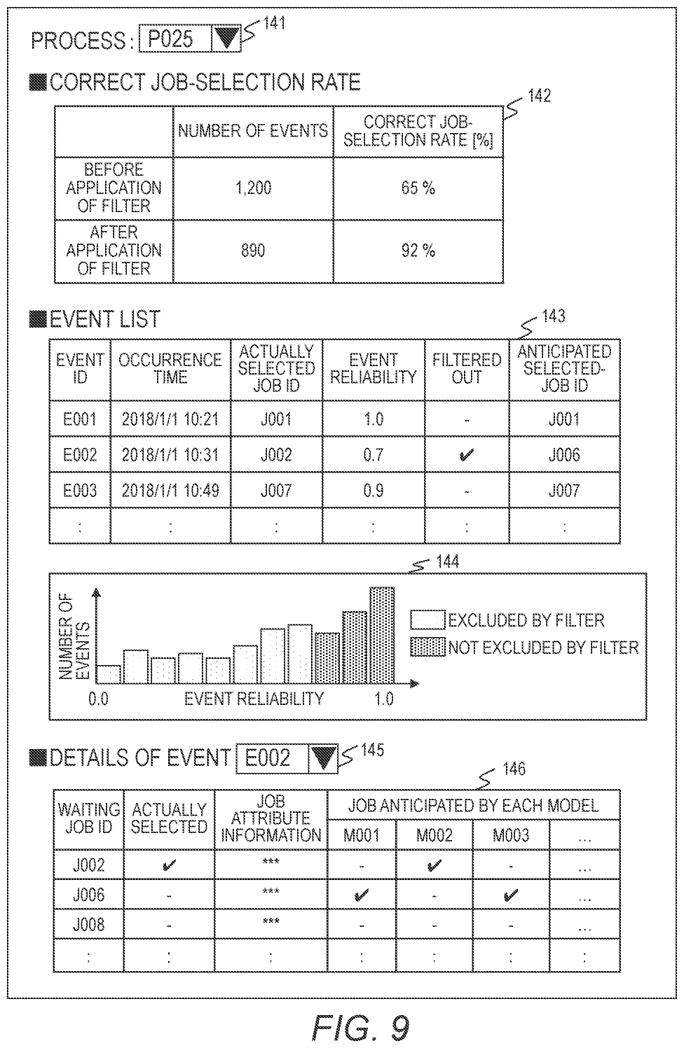

The display unit 140 described with reference to FIG. 2A presents predetermined information with the output device 352, utilizing the information stored in the storage unit 120. For example, the display unit 140 presents information on the anticipation results of the dispatching rule model set for each process. This information enables the user to check how the filtering works. FIG. 9 provides an example of the image displayed on the output device 352. The image in FIG. 9 is an example; any image can be used as far as the same or like information is presented.

As illustrated in FIG. 9, the image displayed by the display unit 140 includes a process selection region 141, a correct job-selection rate display region 142, an event list display region 143, an event reliability graph display region 144, an event selection region 145, and a detailed event information display region 146, for example.

The correct job-selection rate display region 142 is to display the rate of correct anticipation of a job to be selected by one or more dispatching rule models for the process selected in the process selection region 141 and other information. The correct job-selection rate display region 142 provides correct job-selection rates before and after a filter based on event reliability is applied to the event data. The correct job-selection rate tells the user the accuracy of the created one or more dispatching rule models.

In the correct job-selection rate display region 142, the number-of-events column shows the number of events before and after the event data used to create one or more dispatching rule models is filtered at Step S500 in FIG. 8. The correct job-selection rate column shows a correct job-selection rate of the one or more dispatching rule models created using event data before the filter is applied and a correct job-selection rate of the one or more dispatching rule models created using event data after the filter is applied. In this example, the event data used to calculate the correct job-selection rate is different from the training data used to create the dispatching rule models.

The number of events before and after the filter is applied indicates whether an implicit rule exists. For example, if the number of events is significantly reduced after the filter is applied, the threshold for the reliability is not appropriate or a clear implicit rule for job selection may not exist. The correct job-selection rates indicate the appropriateness of the dispatching rule models generated with filtered data. If the correct job-selection rate after the filter is applied is low or there is no big difference between the correct job-selection rates before and after the filter is applied, the dispatching rule models could be inappropriate.

The event list display region 143 shows a list of events in the process selected in the process selection region 141. The event list display region 143 provides a list of events whose detailed information can be displayed in the detailed event information display region 146. The user can select an event to display the details thereof with reference to the event list display region 143.

The event reliability graph display region 144 shows relations between reliability of event and the number of events in the production record data. Specifically, the event reliability graph display region 144 shows a histogram showing the number of events at each level of event reliability in the event data used to train the dispatching rule models. The event reliability graph display region 144 further distinguish the reliability of the events excluded by filtering and the reliability of the events not excluded by filtering. The histogram of event reliability indicates whether an implicit rule exists. If the peak of the histogram is located near the reliability of 1, the implicit rule is likely to exist. If the peak is located near the reliability of 0, the implicit rule is unlikely to exist. The histogram also indicates the appropriate threshold for the reliability.

The detailed event information display region 146 shows the relations between the record of the event designated in the event selection region 145 and the results of anticipation of the designated event by the plurality of dispatching rule models. Specifically, the detailed event information display region 146 shows a waiting job list in the designated event, the attribute information of each job, and results of anticipation of a job to be selected by each dispatching rule model. The actually-selected column indicates whether the job is actually selected in the event. The job-anticipated-by-each-model column shows the jobs anticipated to be selected in the event by the dispatching rule models that are used to filter event data.

The detailed event information display region 146 indicates whether each dispatching rule model anticipates a job to be selected properly. In the example of FIG. 9, the job J002 is selected in the actual event; however, most of the dispatching rule models anticipate the job J006 to be selected. Accordingly, it can be presumed that the job to be selected in accordance with the implicit rule is the job J006 and the actual event does not conform to the implicit rule. In another case where anticipation results of the dispatching rule models are lacking in unity, the anticipation could be improper and an implicit rule may not exist.

In an example, the user can amend the filter for the event data with reference to the information in the detailed event information display region 146. Specifically, the input unit 110 updates the event table 220 in accordance with an instruction of the user. The dispatching rule model obtainer 132 re-creates one or more dispatching rule models using the updated event data (training data). Through this operation, more appropriate training data is obtained.

In the example of FIG. 9, the event E002 is excluded by filtering as shown in the event list display region 143. This is because the actual event selects the job J002 but many dispatching rule models anticipate the job J006 to be selected.

For example, the user changes the job selected in this event to the job J006 and adds the record to the event data (training data) for creating a new dispatching rule model through the input unit 110. Alternatively, the user can exclude the event determined to be inappropriate from the extracted event data (training data).

The production record data analyzer 100 can execute only part of the above-described processing. For example, all or a part of generation of raw event data, creation of a plurality of dispatching rule model sets for configuring a filter, and creation of a new dispatching rule model can be omitted.

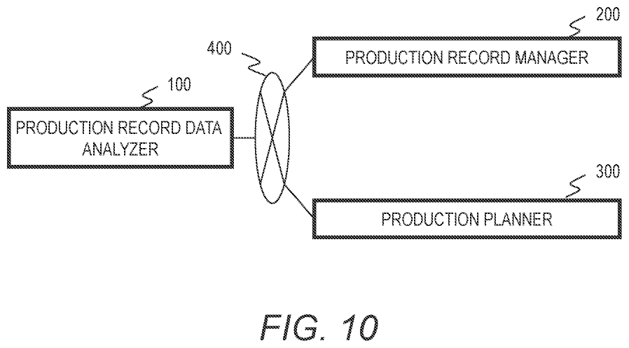

FIG. 10 is a schematic diagram of a production planning system in this embodiment. The production planning system includes a production record data analyzer 100, a production record manager 200, and a production planner 300; these are capable of sending and receiving information via a network 400. The production record manager 200 sends production record data to the production record data analyzer 100 and the production planner 300. The production record data analyzer 100 sends dispatching rule models for each process to the production planner 300. The production planner 300 uses the received dispatching rule models in determining the job sequence in each process in predicting future production. The production planner 300 makes a production plan based on the production prediction.

It should be noted that this invention is not limited to the above-described embodiments but include various modifications. For example, the above-described embodiments provide details for the sake of better understanding of this invention; they are not limited to those including all the configurations as described. A part of the configuration of an embodiment may be replaced with a configuration of another embodiment or a configuration of an embodiment may be incorporated to a configuration of another embodiment. A part of the configuration of an embodiment may be added, deleted, or replaced by that of a different configuration.

The above-described configurations, functions, and processing units, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card or an SD card.

The drawings show control lines and information lines as considered necessary for explanations but do not show all control lines or information lines in the products. It can be considered that most of all components are actually interconnected.

What is claimed is:

1. A production record data analyzer comprising:
one or more storage devices; and
one or more processors,
wherein the one or more storage devices store:
a plurality of dispatching rule model sets; and
event data in production record data,
wherein the event data includes information on events in each of a plurality of processes,
wherein an event is that a job to be executed next in a process is selected from jobs waiting to be executed in the process,
wherein each of the plurality of dispatching rule model sets is composed of a plurality of dispatching rule models,
wherein each dispatching rule model in each dispatching rule model set is configured to anticipate a job to be selected next from waiting jobs in an event in a process associated with the dispatching rule model set, and
wherein the one or more processors are configured to:
generate anticipation results of a selected event with the plurality of dispatching rule models of the dispatching rule model set associated with the process;
determine reliability of the selected event based on whether each of the jobs indicated in the anticipation results is the same as the job actually selected in the selected event shown in the production record data in each of the plurality of processes; and
determine whether to include the selected event to training data for generating a new dispatching rule model based on the reliability in each of the plurality of processes.

2. The production record data analyzer according to claim 1, wherein the one or more processors are configured to create a new dispatching rule model using the training data.

3. The production record data analyzer according to claim 1,
wherein the production record data shows a start time and a finish time of each job in each of the plurality of processes, and
wherein the one or more processors are configured to:
generate the event data from the production record data; and
identifying a job selected to be executed next and waiting jobs in each event based on the start times and the finish times of the jobs in generating the event data.

4. The production record data analyzer according to claim 1, wherein the one or more processors are configured to create the plurality of dispatching rule model sets using the event data or event data generated from production record data different from the production record data.

5. The production record data analyzer according to claim 1, wherein at least some of the plurality of dispatching rule models are models configured with different machine learning schemes.

6. The production record data analyzer according to claim 1, wherein at least some of the plurality of dispatching rule models are trained by different datasets.

7. The production record data analyzer according to claim 6, wherein the different datasets are datasets in isolated different periods in production records.

8. The production record data analyzer according to claim 1, wherein the one or more processors are configured to present information on anticipation results by the dispatching rule model set for a designated process with an output device.

9. The production record data analyzer according to claim 1, wherein the one or more processors are configured to present relations between reliability of event and number of events in the production record data with an output device.

10. The production record data analyzer according to claim 1, wherein the one or more processors are configured to:
present relations between a record of a designated event and anticipation results of the designated event by the plurality of dispatching rule models associated with the designated event with an output device; and
receive amendment to the training data through an input device.

11. A method for a production record data analyzer to analyze production record data,
the production record data analyzer including a plurality of dispatching rule model sets and event data in production record data,
the event data including information on events in each of a plurality of processes,
an event being that a job to be executed next in a process is selected from jobs waiting to be executed in the process,
each of the plurality of dispatching rule model sets being composed of a plurality of dispatching rule models,
each dispatching rule model in each dispatching rule model set being configured to anticipate a job to be selected next from waiting jobs in an event in a process associated with the dispatching rule model set, and
the method comprising:
generating, by the production record data analyzer, anticipation results of a selected event with the plurality of dispatching rule models of the dispatching rule model set associated with the process;
determining, by the production record data analyzer, reliability of the selected event based on whether each of the jobs indicated in the anticipation results is the same as the job actually selected in the selected event shown in the production record data; and
determining, by the production record data analyzer, whether to include the selected event to training data for generating a new dispatching rule model based on the reliability,
in each of the plurality of processes.

12. A non-transitory computer-readable storage medium storing commands to make a computer system to execute production record data analysis,
wherein the computer system includes a plurality of dispatching rule model sets and event data in production record data,
wherein the event data includes information on events in each of a plurality of processes,
wherein an event is that a job to be executed next in a process is selected from jobs waiting to be executed in the process,
wherein each of the plurality of dispatching rule model sets is composed of a plurality of dispatching rule models,
wherein each dispatching rule model in each dispatching rule model set is configured to anticipate a job to be selected next from waiting jobs in an event in a process associated with the dispatching rule model set, and
wherein the production record analysis includes:
generating, by the computer system, anticipation results of a selected event with the plurality of dispatching rule models of the dispatching rule model set associated with the process;
determining, by the computer system, reliability of the selected event based on whether each of the jobs indicated in the anticipation results is the same as the job actually selected in the selected event shown in the production record data; and
determining, by the computer system, whether to include the selected event to training data for generating a new dispatching rule model based on the reliability,
in each of the plurality of processes.
